(19) United States
(12) Patent Application Publication
(10) Pub. No.: US 2006/0061550 A1
(43) Pub. Date: Mar. 23, 2006

(54) Display size emulation system

(76) Inventor: Sina Fateh, Sunnyvale, CA (US)

Correspondence Address: PERKINS COIE LLP, P.O. BOX 2168, MENLO PARK, CA, 94026, US

(21) Appl. No.: 11/223,451

(22) Filed: Sep. 8, 2005

Related U.S. Application Data
(63) Continuation of application No. 09/328,053, filed on Jun. 8, 1999.
(60) Provisional application No. 60/119,916, filed on Feb. 12, 1999.

(51) Int. Cl. G09G 5/08

(52) U.S. Cl. 345/158

(57) ABSTRACT

The present invention relates to controlling displays of user interfaces. More specifically, the invention relates to emulating motion driven navigation commands for the manipulation of displays of computer software application.

### CROSS REFERENCE TO RELATED APPLICATION

This application is a continuation in part of Flack et al.'s co-pending U.S. patent application Ser. No. 09/328,053, filed Jun. 8, 1999 and entitled “Motion Driven Access To Object Viewers,” which is incorporated herein by reference in its entirety.

### BACKGROUND OF THE INVENTION

The present invention relates to controlling displays of user interfaces. More specifically, the invention relates to emulating motion driven navigation commands for the manipulation of displays of computer software applications.

In the two decades, enormous progress has occurred in developing and perfecting interactions between humans and computer systems. Improvements in user interfaces along with improvements in data capacity, display flexibility, and communication capabilities have lead to the widespread use of applications such as Internet browsers, e-mail, map programs, imaging programs and video games that can be generally described as providing content-rich information to the user. The following highlights of computer interface evolution are illustrative, providing a basis for understanding the utility of the invention claimed herein.

In the beginning of the personal computer era, the desktop computer, which is still in use today, dominated the market. Prior art FIG. 1 portrays a traditional desktop computer human interface 10. The traditional desktop computer 10 typically includes a display device 12, a keyboard 14, and a pointing device 16. The display device 12 is normally physically connected to the keyboard 14 and pointing device 16 via a computer. The pointing device 16 and buttons 18 may be physically integrated into the keyboard 14. In the traditional desktop computer human interface 10, the keyboard 14 is used to enter data into the computer system. In addition, the user can control the computer system using the pointing device 16 by making selections on the display device 12. For example, using the pointing device the user can scroll the viewing area by selecting the vertical 38 or horizontal 36 scroll bar.

As semiconductor manufacturing technology developed, portable personal computers such as notebook and hand held computers became increasingly available. Notebook and hand held computers are often made of two mechanically linked components, one essentially containing the display device 12 and the other the keyboard 14 and pointing device 16. Hinges often link these two mechanical components with a flexible ribbon cabling connecting the components and embedded in the hinging mechanism. The two components can be closed like a book, often latching to minimize inadvertent opening.

The notebook computer greatly increased the portability of personal computers. However, in the 1990's, a new computer interface paradigm emerged which enabled even greater portability and freedom and gave rise to the Personal Digital Assistant 20 (herein referred to as “PDA”). One of the first commercially successful PDAs was the Palm product line (PalmPilot™) now manufactured by Palm, Inc. These machines are quite small, lightweight and relatively inexpensive, often fitting in a shirt pocket, weighing a few ounces and costing less than $400 when introduced. These machines possess very little memory (often less than 2 megabytes), a small display 28 (roughly 6 cm by 6 cm) and no physical keyboard. The pen-like pointing device 26, often stored next to or on the PDA 20, is applied to the display area 28 to enable its user to make choices and interact with the PDA device 20. External communication is often established via a serial port (not shown) in the PDA connecting to the cradle 22 connected by wire line 24 to a traditional computer 10. As will be appreciated, PDAs such as the PalmPilot™ have demonstrated the commercial reliability of this style of computer interface.

FIG. 2 displays a prior art Personal Digital Assistant 20 in typical operation, in this case strapped upon the wrist of a user. At least one company, Orang-otang Computers, Inc., sells a family of wrist mountable cases for a variety of different PDAs. The pen pointer 26 is held in one hand while the PDA 20 is held on the wrist of the other hand. The display area 28 is often quite small compared to traditional computer displays 12. In the case of the Palm product line, the display area 28 contains an array of 160 pixels by 160 pixels in a 6 cm by 6 cm viewing area. Often, part of the display area is further allocated to menus and the like, further limiting the viewing area for an object such as an e-mail message page. This limitation in viewing area is partially addressed by making the menu bar 34 (FIG. 1) found on most traditional computer human interface displays 12 invisible on a PDA display 28 except when a menu button 29 is pressed.

Object database programs, such as map viewers, present a fairly consistent set of functions for viewing two-dimensional sheets. Where the object being viewed is larger than the display area of the display, controls to horizontally and vertically scroll the display area across the object are provided. Such viewing functions often possess visible controls accessed via a pointing device. As shown in FIG. 1, horizontal scrolling is often controlled by a slider bar 36 horizontally aligned with a viewing region 40. Vertical scrolling is often controlled by a vertical slider bar 38 vertically aligned with the viewing region 40. Additionally such database interfaces often possess functionality to scroll in directions other than the vertical and horizontal orthogonal directions. This function is usually controlled by pointing to an icon, such as hand icon 42, which is then moved relative to the viewing area 40 while holding down the button 18. Furthermore, additional pages of the same document are viewed by pointing to an icon within the menu bar 34 or depressing a key on the keyboard 14.

Traditional computer human interfaces 10, 20 have been employed in a variety of contexts to provide interactivity with multi-dimensional and/or multi-tiered object programs and systems. These interfaces superficially appear capable of providing a reasonable interface. However, size limitations and associated barriers drastically limit their functionality and interactivity. Various methods have been devised to activate pan and scroll functions such as pushing an “arrow” key to shift the display contents in predefined increments in the direction indicated by the arrow key. Alternatively, a pen pointer or stylus can be used to activate pan and scroll functions to shift the display contents. When the desired size (e.g. width and/or height) of the object's display format is larger than the size of the display screen itself, control panels, e.g., scroll bars, appear within the viewable screen to indicate that the image extends beyond the borders of the viewable screen. This further limits the amount of information that is viewable on the display screen. Given the relative small size of the display screens used on the current hand held devices, the percentage of viewable screen space occupied by these control panels becomes increasingly large. The management of viewable screen space becomes much more critical.

Prior art FIG. 3 shows the path of communication between an application 350 and the input device 310 for a typical data processing system 300. An input command, e.g., a mouse button click or a mouse ball input, is passed from the input device 310 to the input device driver 320. The device driver 320 converts the input into a standard application command, e.g., click select command or a scroll command where it then passes the command to the operating system 330. The operating system 330 communicates with the operable application 350 through a Graphic User Interface (GUI) environment where input commands are converted to on-screen activities. When the operating system 330 receives, for example, a scroll command, it communicates with the GUI 340 to display the command on a display device 370. The scroll command would be displayed as a cursor clicking a scroll bar select button. The operable application 350 then reflexes the input and the process is repeated with a variety of commands.

Several prior art inventions have addressed some of the problems in manipulating applications on small screen devices and how to display a maximum amount of data to a user on a limited display screen. For example, U.S. Pat. No. 5,602,566 provides scrolling commands via tilting input of the hand held device, while U.S. Pat. No. 5,526,481 teaches mounting a mouse type device to the underside of the hand held device and activating scroll commands through the movement of the device across a work surface. Other relevant prior art includes U.S. Pat. No. 6,069,626 which teaches a transparent scrollbar, so that the full display area is still used to show data, and U.S. Pat. No. 5,510,808 which teaches a method for allowing the user to have the option of having a scrollbar.

In general, all the prior art devices suffer from limited input commands as well as some sort of limitation or blockage of the viewable screen space. If the display is small relative to the object to be viewed, many individual steps are necessary for the entire object to be viewed as a sequence of display segments. This process may require many sequential command inputs using arrow keys or pen taps, which is tedious. Most input commands are accomplished through interactive display features or “buttons” located within the viewable space of the display device. These buttons further limit the space available to displaying information.

The proliferation of motion sensor input devices such as accelerometers or gyroscopes create more problems of compatibility and communication with standard operating systems and applications. While such input devices make many of the interactive displays, like buttons and scroll bars, unnecessary, no means exists by which such displays are removed from the display.

What is needed is a system that maximizes display space and emulates common control input commands from input devices such as accelerometers or gyroscopes. The system maximizes display space and provide display control convenience by manipulating display information received by applications run on systems, where the computational device is incorporating such input devices.

### SUMMARY OF THE INVENTION

The present invention addresses the aforementioned problems by providing a new method for emulating traditional input commands for non traditional input devices. In particular, the present invention can convert motion and acceleration commands into standard operating system and application commands. Furthermore, the present invention provides a method for manipulating the information received by an application in a way that stops unnecessary information or displays from being generated by the application.

A device in accordance with one embodiment of the present invention includes a digital processor, a computer memory, a computer readable medium, a motion sensor, a display device, and a computer emulation layer. The digital processor is operable to map information resident in the computer readable medium into a virtual display space suitable for conveying the information to the user. The motion sensor device is interfaced to the computer emulation layer providing it from time to time with motion data vector. The computer emulation layer converts the motion data vector information into standard input commands such as scroll, page down, zoom or cursor commands. The digital processor is then able to communicate with a computer application using the standard set of input commands common to all applications. The emulation layer also manipulates the information received by the application in a way that stops it from displaying unnecessary information, such as scroll bars or page up buttons.

In a preferred embodiment the display device is located on a hand held device such as a hand held computer or mobile communication device capable of displaying text and/or graphical information, albeit on a display sized appropriately for a hand held, wearable or pocket personal information appliance.

### BRIEF DESCRIPTION OF THE DRAWINGS

FIG. 1 displays a prior art system including a traditional computer human interface and a Personal Digital Assistant;

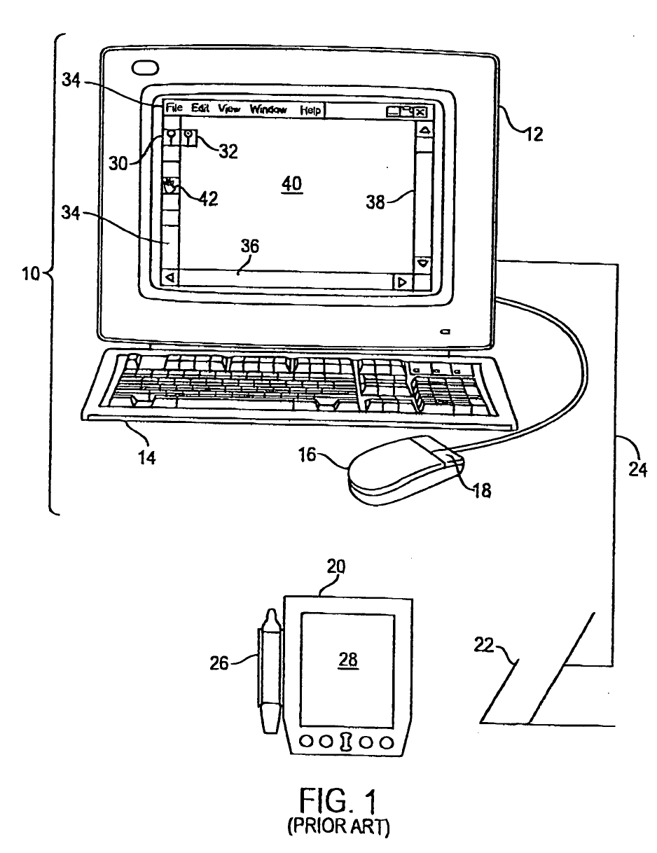

FIG. 2 displays a prior art PDA in typical operation;

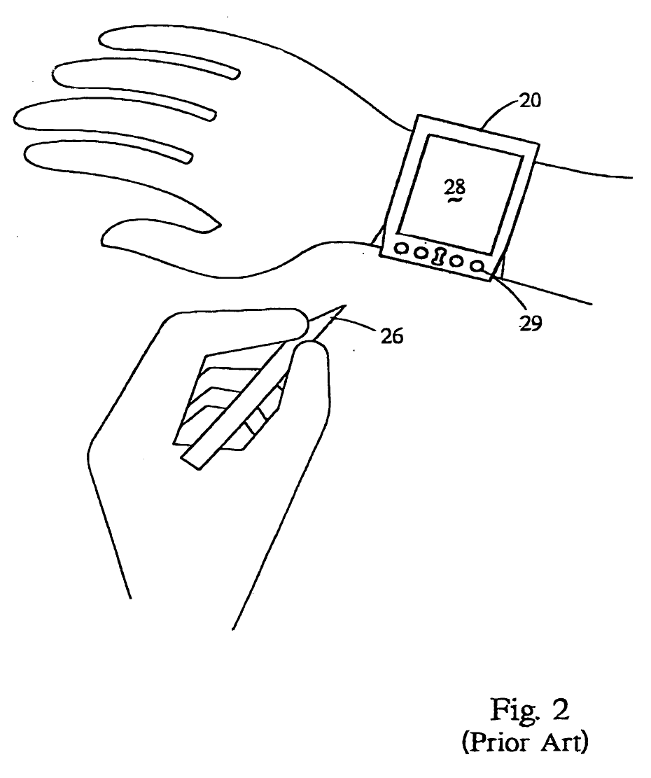

FIG. 3 is a prior art block diagram of a typical data processing system;

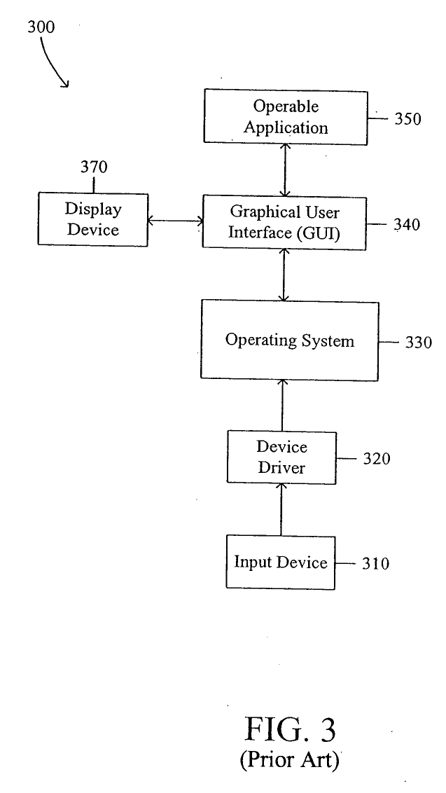

FIG. 4 is a block diagram of the data processing system suitable for practicing the invention;

FIG. 5 illustrates a PDA incorporating a motion sensor device;

FIG. 6 is an example of a PDA implementing the present invention;

FIG. 7 is an alternate embodiment of the present invention in which the virtual desktop includes scrollbars;

FIG. 8 is another view of the present invention as implemented on a PDA in which the scrollbars have been removed.

### DEFINITIONS

The following expressions are used in the detailed description:

“Motion sensor” is any device used to detect motion in Cartesian, cylindrical, or spherical coordinates, and would include, but not be limited to: accelerometers, gyroscopes, inertial sensors, etc.

“Virtual display” or “Virtual desktop” is used to define the total display required of a software application at any given moment. Usually the virtual desktop is greater than the available screen space. For example, in a text editing software program, only one page (or a fraction thereof) would be displayed, where as the virtual display or virtual desktop would comprise the whole multi-page document. The virtual display is usually stored in a memory buffer so that it may be accessed efficiently by the display driver. The virtual display may also be referred to as “work area” or “presentation area.”

“GUI” or “Graphical User Interface” is the operating system's display interface on a computing device.

“Input means” covers any method that can be used to input information into a computing device, PDA, cellphone, or like device and would include, but is not limited to: keyboards, touchpads, mice, drawing tablets, motion sensors, cameras, light sensors, scanners, speech recognition units, buttons, pen computing tablets, and touchscreens.

“Display means” covers any system that a computing device, PDA, cellphone, or like device uses to convey visually represented information to a user, and includes LCD and LED screens, raster displays, and methods.

### DETAILED DESCRIPTION OF THE INVENTION

If the input device is an accelerometer or other motion sensor, user input can be accomplished through movement of the computer or PDA device. Since the manipulation of the application occurs through the user's movement of the PDA, there is no need to reflect the input through the GUI.

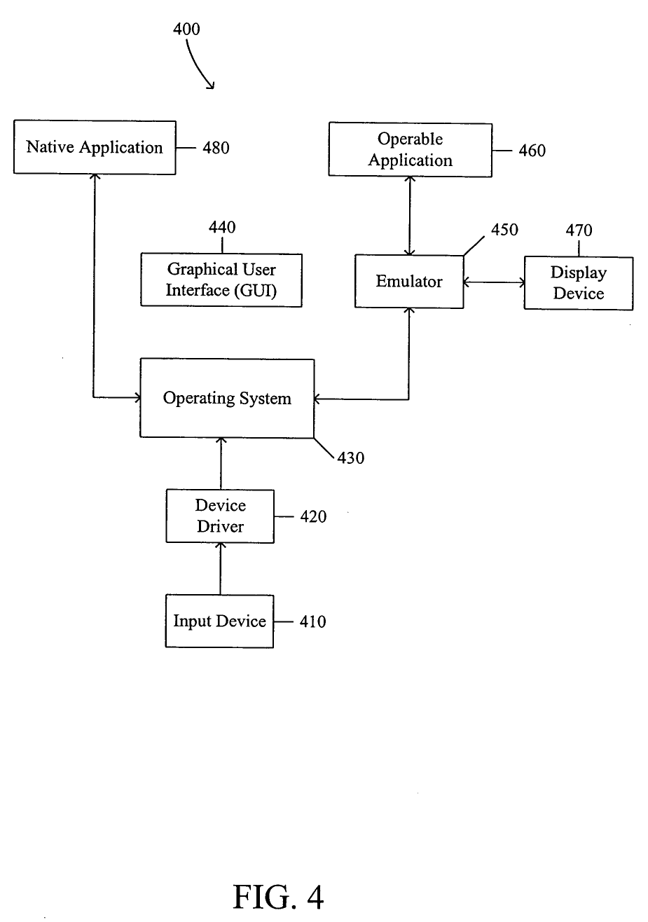

Referring now to FIG. 4 a block diagram of the data processing system 400 suitable for practicing the present invention is shown. The user moves the PDA 20 in a horizontal direction away from their body and the motion sensor input device 410 communicates this information to the device driver 420. As an example, the horizontal movement described above will be considered a scroll-up command wherein the distance of the movement directly relates or is proportional to the amount of scroll. So, if the PDA 20 is moved half an inch, the document being displayed is scrolled by half an inch. In the alternative the scrolling is scaled appropriately, such as a inch of movement equaling a quarter inch of scrolling. The device driver 420 then sends the scroll-up command information to the operating system 430. Since the scroll-up command is related directly to the movement, the operating system 430 has no need to send the command information to the GUI 440 since such command information does not need to be reflected on the display device 470. Since the operable application 460 is designed to communicate with the GUI 440 through commands as they are mirrored on the display device 470, the GUI 440 is incapable of communicating scroll commands to the operable application 460 when the input does not require a graphic representation. The command information is then sent to an emulator 450. The emulator 450 acts as a link between the operating system 430 and the operable application 460. The emulator 450 takes the place of the GUI 440 when the input command information is independent of graphical display. In the present example, the emulator 450 communicates a scroll-up command to the operable application 460 without the need to reflect the command information on the display screen 470. Since the operable application 460 is designed to communicate through a graphic display, the emulator 450 emulates the graphic information without sending the command information to the display device 470. The scroll-up command can then be sent to the operable application 460 without the need to show the scroll bar being manipulated on the display devices 470.

The emulator 450 also communicates with the operable application 460 to manipulate the information received by the operable application 460. For instance, since scroll-up commands now input through motion of the PDA 20 and not through interaction with the graphical scroll bar, the application would not need to generate the scroll bar on the display device 470. The emulator 450 would then manipulate the information received by the operable application 460 such that the scroll bar is not generated. Similar manipulations can be done to hide buttons or scroll bar type displays generated by the operable application 460 that are rendered unnecessary through the use of a motion sensor or accelerometer input devices 410.

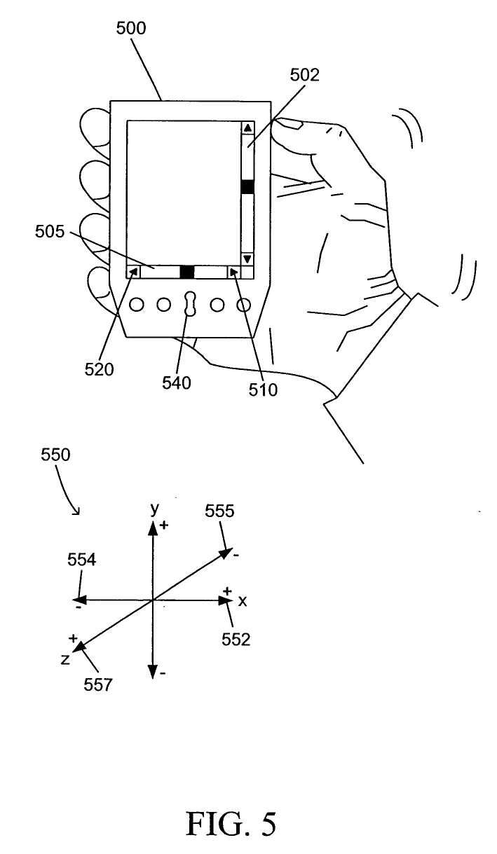

FIG. 5 shows a PDA incorporating a motion sensor as is part of the present invention. The motion sensor (not shown) 410 detects movement of the PDA 500 in a three dimensional space represented by the 3-D reference frame 550. In this manner, particular input commands may be assigned for any given movement. For instance, a scroll right command 510 may be assigned to movement of the PDA 500 along the positive X-axis 552 and a scroll left command 520 may be assigned to movement of the PDA 500 along the negative X-axis 554. The operable PDA application 460 is set up to receive a scroll command by either manipulating the vertical scroll bar 502 or the horizontal scroll bar 505 directly, or by activating a scroll button 540 located on the PDA 500. The present invention converts the motion input commands into a form recognized by the application 460. In this example, the movement of the PDA 500 in the direction of the positive X-axis 552 would be translated by the emulator 450 and sent to the operating system 430 as a scroll right command.

Many other examples of movement input methods may be emulated as common application input commands, as can be appreciated by those skilled in the art. For instance, moving the PDA along the positive Z-axis 557 could be converted by the emulator 450 as a zoom-in command. Similarly, a movement in the direction of the negative Z-axis 555 could be emulated as a zoom-out command. A quick movement along the positive Z-axis 557 could be translated into a page up command by the emulator 450 and a quick movement in the direction of the negative Z-axis 555 could be translated as a page down command. The present invention therefore allows for interaction and manipulation of all computer applications by emulating the common commands the application is designed to receive regardless of the input device. The motion sensor input method may then be used in conjunction with all current applications with out the need to modify the application in any way.

When motion sensor technology is used in conjunction with portable computers and PDA devices, many common application interface functions become unnecessary. For instance, since using the present invention scroll commands may be input through user movement of the PDA, the generation and use of scroll bars becomes unnecessary.

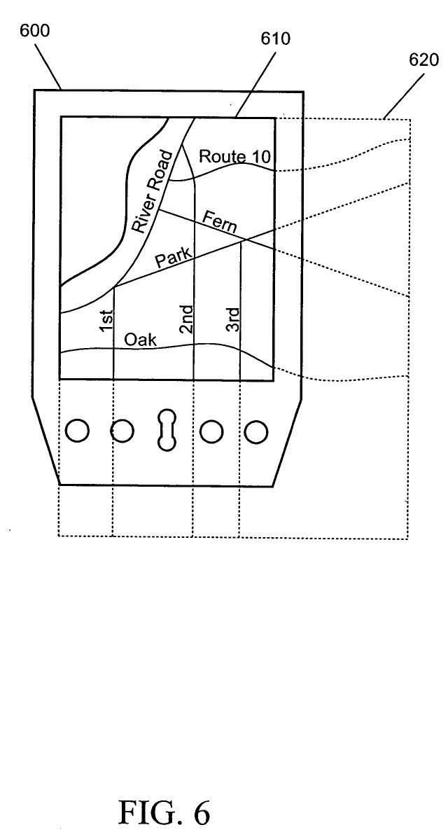

FIG. 6 illustrates one embodiment of the present invention using the motion sensor input display commands described above.. The emulator 450 identifies the times at which the information obtained from the database 620 can not be displayed within the viewable display screen 610 of the PDA 600. At this time, the emulator 450 communicates with the operable application 460 to tell it that the obtained information 620 is in fact smaller then it actually is. That is, the information embodied in the virtual display will take up less viewable space than it actually does. The operable application 460 now believes the information will fit within the available size of the display 610 and will therefore not generate a scroll bar.

In an alternate embodiment, depending on the configuration of the device 600, it may be necessary for the emulator 450 to communicate directly with the operating system 430 instead of the operable application 460 that the virtual display will fit within the available display. Such a scenario is more likely if the operating system user interface handles most of the display operations, such as scroll bar creation, and is not dependent on the operable application 460 for the generation of display interfaces.

In a typical operation of the present invention, neither the operable application 460 nor operating system 430 is generating a scroll bar, nor will they be able to receive scroll bar type commands via manipulation of the scroll bars. The emulator 450 therefore receives the scroll bar type commands from the motion sensor input 410 and sends them to the operable application 460 even though the scroll bar is not being generated by the application. This way, the operating system 430 receives standard scroll bar type command even though the application 460 is not displaying a scroll bar.

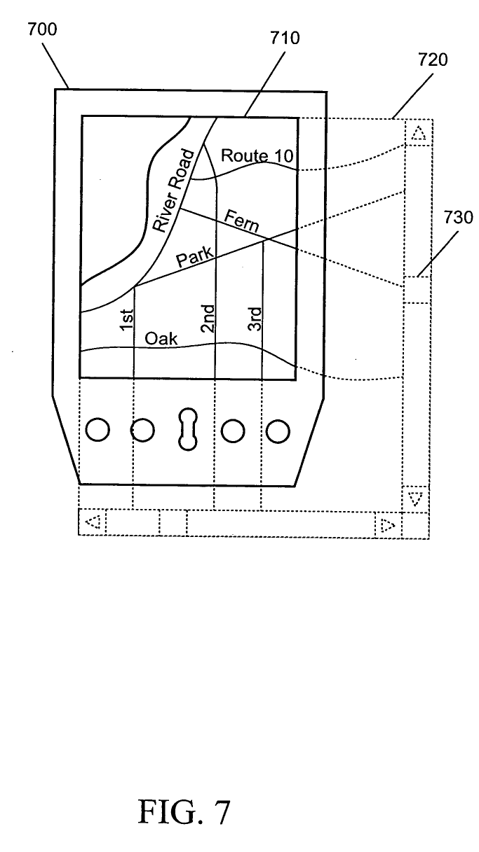

FIG. 7 illustrates another embodiment of the present invention. The emulator 450 identifies the times at which the information obtained from the database 720 can not be displayed within the viewable display screen 710 of the PDA 700. The emulator 450 then communicates with the application 460 to tell it that the viewable display screen 710 is larger then it is in actuality. The information that exists outside of the viewable area of the viewable display screen 710 is the scroll bar information 730. Since the scroll bar is being generated by the operable application 460, the application 460 is able to receive scroll bar commands even though the scroll bars are not viewable within the viewable display screen 710. In this way, the emulator 450 only needs to convert the movement information into scroll bar commands.

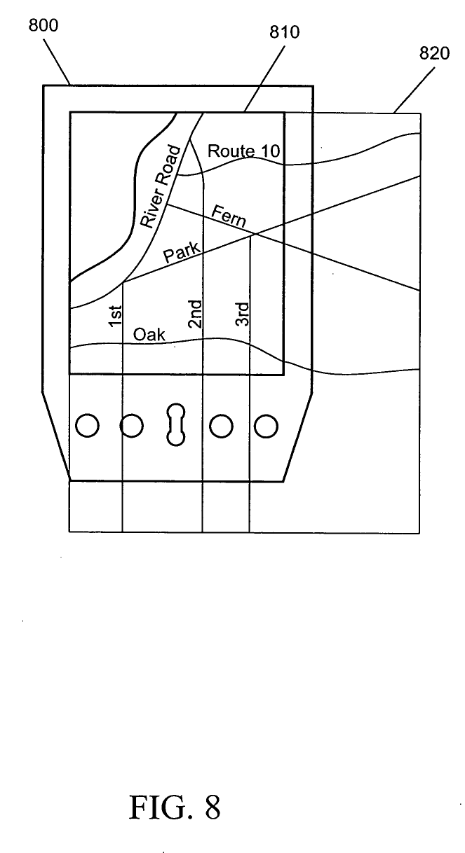

Referring now to FIG. 8, another embodiment of the present invention, the emulator 450 identifies the times at which the information obtained from the database 820 can not be displayed within the viewable display screen 810 of the PDA 800. The emulator 450 then communicates with the operable application 460 to tell it that the viewable display screen 810 is as large as or larger then the information obtained from the database 820. The operable application 460 will now believe that the information will fit within the viewable display screen 810. The operable application 460 will then not generate scroll bars. Normally, now that the operable application 460 is not generating a scroll bar, it will not receive scroll bar commands from an input device 410. The emulator 450, therefore, receives the scroll bar type commands from the motion sensor 410 and sends them to the operable application 460, even though the scroll bar is not being generated by the operable application 460. As can be appreciated by the those skilled in the art, the emulator 450 can also actively samples the operating system 430 or the input device 410 to identify changes in the display 810 at regular intervals.

Although the invention has been described above in the context of graphical data, it should be realized that the teachings of the invention have a wider scope and are applicable to a number of different types of display information and systems. Furthermore, the application information indicia disclosed above are not limited to the practice of the invention to only these examples. Thus, while the invention has been particularly shown and described with respect to a presently preferred embodiment thereof, it will be understood by those skilled in the art that changes in form and details may be made therein without departing from the scope and spirit of the invention.

1. An emulator designed to be executed on a portable electronic device with a display, wherein said emulator receives input from at least one motion sensing device;
wherein a virtual display is accessed by said emulator;
wherein at least a portion of said virtual display is displayed on said display in one time interval;
wherein said input from said at least one motion sensing device being for controlling a displayed portion of said virtual display; and
wherein said displayed portion being the same size as said display.

2. The emulator as recited in claim 1, wherein said virtual display is comprised of the entire display information of a computer application executing on said device in one time interval.

3. The emulator as recited in claim 1, wherein a set of graphical user interface features are only present in said virtual display.

4. The emulator as recited in claim 3, wherein said set of graphic user interface features include at least one scroll bar, said at least one scrollbar being displayed so as to occupy a linear region that is bounded by the boundaries of said virtual display.

5. The emulator as recited in claim 1, wherein said emulator is located on an application specific integrated circuit.

6. The emulator as recited in claim 1, wherein said emulator is located on a distributed system.

7. The emulator as recited in claim 1, wherein said virtual display is stored on said emulator.

8. A method of controlling a display device of a computer system, said display device having a display area, comprising the steps of:
executing a computer application that has a virtual display that is larger than said display area;
communicating to an operating system that said virtual display can fit on said display area; and
displaying only a portion of said virtual display on said display device;
whereby, said display does not display features that would normally be displayed by said operating system, if said virtual display could not fit in said display area.

9. The method of claim 8 further comprising the step of restricting the display of a scrollbar within said display area of said display device.

10. The method of claim 8 wherein said step of communicating to the operating system is performed by an emulation layer, said emulation layer being for bypassing a graphical user interface on said display device.

11. The method of claim 8 further including a step of providing a touch screen in said display area of said display device.

12. The method claim 8 further including the act of communicating to an operating system that said virtual display of said computer application will fit within said display area.

13. The method of claim 8, including the act displaying at least one scrollbar having an indicator for indicating a position of said display area within said virtual display, said at least one scrollbar being displayed so as to occupy a linear region this is bounded by first and second ends that represent an extent of said virtual display.

14. A computer system having a display area, comprising:
a) a computer application, displayed on said display area, having a virtual display that is larger than said display area;
b) an operation system for determining the size of said display area and the size of the virtual display of said computer application; and
c) an emulation layer for communicating with said operating system means that the computer application virtual display can fit within said display area.

15. The computer system as recited in claim 14 wherein said operating system means does not display a scrollbar on said display area.

16. The computer system as recited in claim 14, which further includes a touch sensitive screen.

17. The computer system as recited in claim 14, wherein said operating system displays a portion of said virtual display on said display area.

18. The computer system as recited in claim 14, further comprising an input means for scroll commands.

19. The computer system as recited in claim 18, further comprising a driving means that receives scroll commands from the input means.

20. The computer system as recited in claim 19, wherein said operating system means converts signals from said driving means into scroll commands.

21. The computer system as recited in claim 20, wherein said input means comprises an accelerometer.

22. The computer system as recited in claim 20, wherein said input means comprises an gyroscope.

23. The computer system as recited in claim 20 wherein said input means comprises a set of motion sensing devices.

24. A method for controlling a display comprising the acts of:
providing a display area;
providing a computer application that will be displayed on said display area, wherein said computer application will require a larger area than said display area;
providing an operating system to display said computer application; and
providing an emulation layer that emulates a screen size to the operating system which is large enough to display the entire computer application; and
displaying said computer application.

25. The method as recited in claim 24, wherein said act of displaying comprises displaying only a portion of said computer application.

26. The method as recited in claim 24, further comprising the act of specifying scroll commands from input hardware.

27. The method as recited in claim 26, further comprising the act of providing an accelerometer as the input hardware.

28. The method as recited in claim 26, further comprising the act of providing the commands from the input hardware into a driving means.

29. The method as recited in claim 28, further comprising the act of inputting commands from said driving means into said operating system means.

30. In a computer system of a portable electronic device including a graphical user interface and a display device and input means, a method of providing a, the method comprising:
a) removing a current display from graphical user interface from said display device;
b) displaying a emulation graphic interface on said display device;
c) receiving input from a motion sensing means; said motion sensing means for detecting a user initiated motion of said device; and
d) adjusting said emulation graphic interface displayed on said display device, according to said received input;
wherein said emulation graphic layer is independent of the display requirements of said display device.

31. The method as recited in claim 30, wherein said removing step is preceded by an additional activation step initiated by a user.

32. The method as recited in claim 30, wherein said adjusting step is further comprised of the following acts:
a) processing said user initiated motion of said device;
b) determining a corresponding display command based on said processing; and
c) performing said corresponding display command.

33. The method as recited in claim 32, wherein said corresponding display command allows a user to view any part of a virtual display, said virtual display created by a computer application by movement of said device.

34. The method as recited in claim 32, wherein said corresponding display command allows a user to magnify a localized region of a virtual display, said virtual display created by a computer application, by movement of said device.

35. The method as recited in claim 32, wherein said corresponding display command allows a user to demagnify a localized region of a virtual display, said virtual display created by a computer application by movement of said device.

36. The method as recited in claim 32, wherein said corresponding display command allows a user to reorient a localized region of a virtual display, said virtual display created by a computer application, by movement of said device.

37. The emulator as recited in claim 1, wherein said emulator replaces an existing graphical user interface on said display.
